(19) United States
(12) Patent Application Publication
(10) Pub. No.: US 2006/0242855 A1
(43) Pub. Date: Nov. 2, 2006

(54) Rotating steam drying apparatus

(75) Inventor: Olli Tiitu, Parkano (FI)

Correspondence Address: CROWELL & MORING LLP;INTELLECTUAL PROPERTY GROUP, P.O. BOX 14300, WASHINGTON, DC, 20044-4300, US

(73) Assignee: Konepaja Kopar Oy, Parkano (FI)

(21) Appl. No.: 10/542,223

(22) PCT Filed: Sep. 10, 2004
(86) PCT No.: PCT/FI04/00526

§ 371 Date: Jul. 14, 2005

(30) Foreign Application Priority Data
Sep. 11, 2003 (FI) 20031304

(51) Int. Cl. D06F 58/00; F26B 11/02; F26B 19/00

(52) U.S. Cl. 34/124; 34/119; 34/212; 34/134

(57) ABSTRACT

A drying apparatus comprises a cylindrical rotatable drum (1), the inside of which is provided with a steam pipe system consisting of heat transfer elements (7), to be rotated with the drum. The heat transfer elements (7) are detachable from and mountable on the drum (1). Material to be dried is fed to a first end of the drying apparatus, the material being arranged to be discharged through a second end of the drying apparatus. The heat transfer element (7) is formed as a uniform packet of several longitudinal pipes (8) and connecting pipes (9) between them in such a way that the structure of the heat transfer element is formed self-supporting and that this self-supporting packet is attached to the drum (1) frame with fastening that allows heat expansion.

### BACKGROUND OF THE INVENTION

The invention relates to a drying apparatus comprising a cylindrical rotatable drum, the inside of which is provided with a steam pipe system consisting of heat transfer elements, to be rotated with the drum, the heat transfer elements being detachable from and mountable on the drum, whereby material to be dried is fed to a first end of the drying apparatus, the material being arranged to be discharged through a second end of the drying apparatus.

Enrichments of metal industry can be dried in copper and nickel works with continuous driers, for example. The structure of a continuous drier is typically such that it has a drying drum which is rotated continuously. Material to be dried is brought to the inside of the drum from its first end. During the drying, steam is continuously conveyed to the pipe system inside the drum. The drum is provided with equipment with which it is rotated during the drying. During the drying, the enrichment fed to the drum travels toward the second end of the drum, from where it is discharged. The second end of the drum comprises, for instance, an overflow edge or adjustable discharge openings, and in addition, the inclination of the drum may be adjustable within given limits to control the drying delay of the enrichment in the drum. An example of such a continuous drying drum is presented in Fl patent 102 782.

Also Fl patent 105 130 discloses a continuous steam drier. This steam drier comprises a drying drum, inside which there is a steam pipe system. The steam pipe system is formed of several pipe elements, each of which comprises two axial pipes in the longitudinal direction of the drum and several pipe arches in the transverse direction of the drum, arranged at a distance from each other relative to the longitudinal direction of the drum, to unite the two axial pipes of the pipe element. At the end of the steam drier there is coaxially with the drum a steam manifold, through which the steam intended for the drying is fed to each pipe element in such a way that there is a flexible conduit from the steam manifold to each axial pipe. Each pipe element is attached to the support structure with a connection allowing heat expansion. Each axial pipe is thus in contact with a solid structure at a plurality of points. Since the connection allows heat expansion, the mounting manner of the pipe element is thus what is called floating, in other words it is mounted loosely within given tolerances. When the drier rotates, material to be dried gets to the space between the axial pipe and the grip member, causing abrasive wearing. This structural solution results in the steam-containing axial pipe under pressure abrading at the support point and causing a dangerous situation with the pipe possibly wearing off. In a practical implementation, there have been attempts to solve the problem by welding a separate abrasion resistant plate upon the pipe at the wear point, which, however, makes the structure more complex, and in addition, the abrasion resistant plate requires continuous maintenance. Further, bringing steam to each axial pipe with separate flexible pipe connection means that a large number of flexible conduits are needed and they are exposed to abrasion when dry material flows onto them.

### BRIEF DESCRIPTION OF THE INVENTION

An object of this invention is to provide a drying apparatus that is improved compared with known apparatus.

The drying apparatus according to the invention is characterized in that the heat transfer element is formed as a uniform packet of several longitudinal pipes and connecting pipes between them in such a way that the structure of the heat transfer element is formed self-supporting and that this self-supporting packet is attached to the drum frame with fastening that allows heat expansion.

An essential idea of the invention is that the drying apparatus comprises a cylindrical rotatable drum, the inside of which is provided with a steam pipe system consisting of heat transfer elements and to be rotated with the drum. The heat transfer elements are detachable from and mountable on the drum. The first end of the drying apparatus is provided with material to be dried, which is arranged to be discharged through the second end of the drier. Further, it is essential that the heat transfer element is formed as a uniform packet of several longitudinal pipes and connecting pipes between them in such a way that the structure of the heat transfer element is formed self-supporting, this self-supporting packet being attached to the drum frame with fastening that allows heat expansion. The idea of one embodiment is that the heat transfer element is formed as a sector-shaped packet in such a way that the heat transfer element consists of the several longitudinal pipes at the edge of the elements and of connecting pipes between them. An idea of a second embodiment is that the end of the heat transfer element comprises at least one steam manifold to which several longitudinal pipes are connected, and the steam manifold is connected to a steam pressure vessel at the end of the drum.

An advantage of the invention is that the abrading place in the drying apparatus is not an individual pipe but a support structure of the heat transfer element packet, connected to the drum frame with fastening that allows heat expansion. The whole element is detachable and removable as one packet for maintenance, for example. The sector-shaped heat transfer element packet is compact and easy to arrange in a rotating drum. When the steam manifold is arranged at the end of the heat transfer element, only one pipe or hose is required for connecting each side of the heat transfer element to the steam pressure vessel. Thus, the material to be dried does not damage a large number of pipes or hoses. Also, the pipes or hoses can easily be protected with a casing.

### BRIEF DESCRIPTION OF THE FIGURES

The invention will be explained in greater detail in the attached drawings, of which

FIG. 1 shows schematically a side view and cross-section of a drying apparatus;

FIG. 2 shows schematically an end view and cross-section of the drying apparatus according to FIG. 1;

FIG. 3 shows schematically a detail of a support structure of a heat transfer element and connection of two heat transfer elements; and

FIG. 4 shows schematically an end view of the sector-shaped heat transfer element.

For the sake of clarity, the invention is shown simplified in the figures. Similar parts are denoted with the same reference numerals.

### DETAILED DESCRIPTION OF THE INVENTION

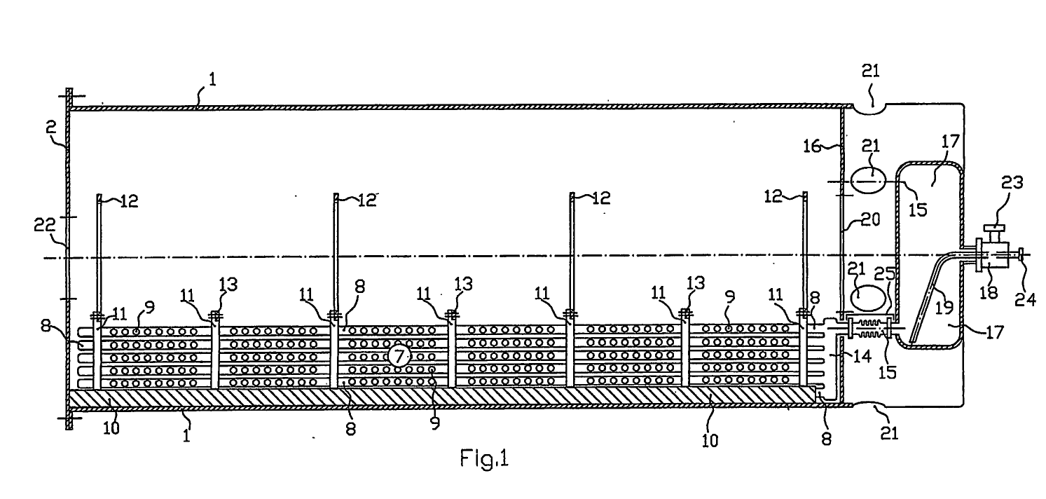

FIG. 1 shows a drying apparatus which is a steam drier and comprises a cylindrical rotatable drum 1. The material to be dried is fed to the inside of the drum 1 through an opening 22 at a first end 2 thereof. The material can be fed in through the opening 22 by means of a belt or screw conveyor, for instance, or another type of appropriate conveyor. The material to be dried may be material of mineral or metallurgic industry, but it may also be any inorganic powdery/granular product or sand that needs final drying prior to further use. Particularly, the drying apparatus is applicable to drying enrichments of metal industry in copper and nickel works.

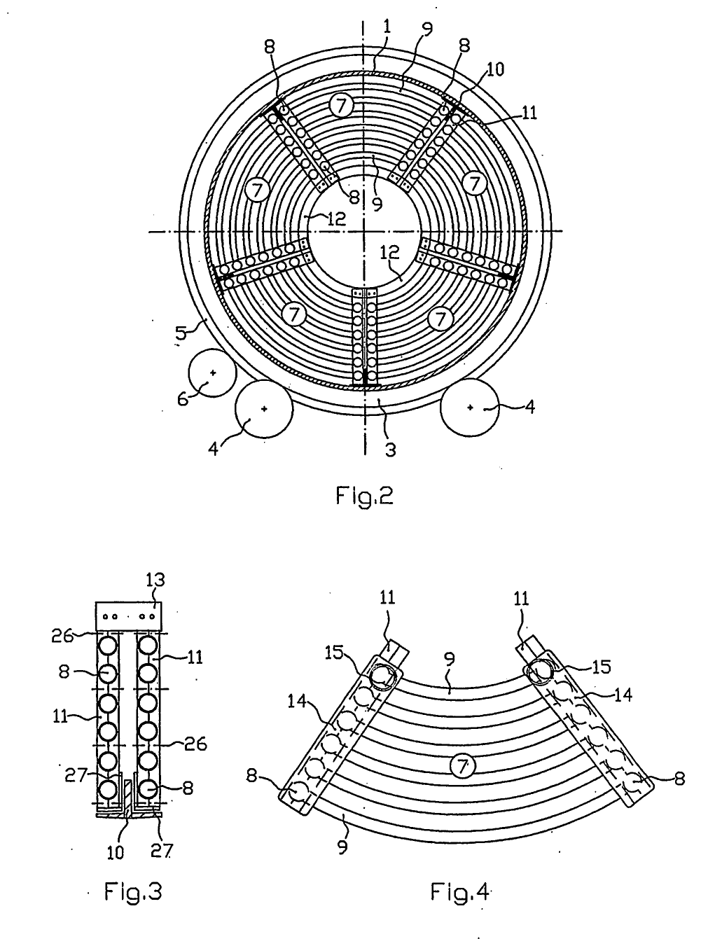

During the drying, the drum 1 is rotated. The support members of the rotating drum 1 are formed of support rims 3 and support wheels 4 supporting them, shown in FIG. 2. For the sake of clarity, FIG. 1 does not show support and rotating equipment of the drum. There may be for example two support rims 3 around the drum, in which case there is typically four support wheels 4. Further, for the sake of clarity, the attached figure does not show motors or gears used for rotating the drum. The drum 1 is rotated by means of a gear rim 5 arranged around the drum and a gearwheel 6 arranged in connection with the gear rim, the gearwheel 6 being thus rotated with a rotating motor.

The material to be dried inside the drum is heated with a pipe system consisting of heat transfer elements 7. FIG. 1 shows only the heat transfer element positioned in the lower part, although naturally there are heat transfer elements arranged around the whole drum 1 in the way shown in FIG. 2. The heat transfer elements 7 are formed as sector-shaped packets. One heat transfer element 7 consists of several longitudinal pipes 8 at the edge of the element and of connecting pipes 9 between them. The heat transfer element 7 is prepared in such a way that it is what is called self-supporting. Thus, the longitudinal pipes are connected to each other by means of support structures 11. The heat transfer elements 7 are supported against longitudinal guides 10 constructed in the drum 1. Adjacent heat transfer elements are supported against each other from the support structure 11 by using ring-like connecting pieces 12, or a binding element 13 connecting two adjacent heat transfer elements 7, or both, as shown in FIG. 1. By means of the ring-like connecting pieces 12, the heat transfer elements 7 are attached to each other as a continuous ring-like structure which, due to heat expansion, is pressed and wedged firmly against the guides 10.

In attaching the heat transfer elements 7 to the drum 1, connections are used which allow heat expansion of the self-supporting heat transfer element packet 7 relative to the drum 1. Changeable abrasion resistant plates 27 are arranged between the support structures 11 and the drum 1. Thus, the movements resulting from heat expansion and rotation mainly wear abrasion resistant plates 27, whereby only they need to be changed in connection with maintenance, whereas the heat transfer elements 7 as such hold even long times without maintenance and change. Further, wearing is subjected more to the support structure 11 than to the longitudinal pipes 8, because these pipes 8 are connected to the support structure 11 and only this support structure 11 is attached to the frame of the drum 1 with fastening allowing heat expansion. The whole heat transfer element 7 can be removed from the drum 1 through a detachable end wall 2.

As mentioned, the material to be dried is conducted to the inside of the drum 1 through the opening 22 at the end 2. Typically, the drum 1 is mounted in a position inclined slightly downwards relative to the direction of travel of the material; in other words, the right side of the edge is usually lower than left side edge. The material to be dried and the replacement air used for removing evaporated moisture are conducted in through the opening 22 at the end 2, and the dry material is removed through an opening 20 on an intermediate wall 16, and further out of the drying apparatus through the openings 21 on the casing of the drum 1. Further, also the water vapour evaporated from the material to be dried and the replacement air used in the drying travel through the openings 21.

The edge of the opening 20 on the intermediate wall 16 may be an adjustable overflow edge, by means of which the drying delay of the material under drying is controlled. Further, the intermediate wall 16 may also be provided with other adjustable discharge openings.

FIG. 3 shows a detail of the support structure 11 of a heat transfer element and the binding element 13 connecting two heat transfer elements 7. The support structure 11 has two parts, so that the longitudinal pipes 8 are positioned tightly in the space between the two halves of the support structure 11. The halves of the support structure 11 are attached to each other with fixing members 26. For example a bolt and a nut may be used as the fixing member 26. Changeable abrasion resistant plates 27 are attached to the support member 11, which plates are positioned against the guide 10 fixed to the drum 1.

One end of the longitudinal pipes 8 of the heat transfer elements 7 is closed, and the other end has a common edge-specific steam manifold 14 of the heat transfer element. This steam manifold 14 is in connection with a steam pressure vessel 17 at the end of the drum 1 with one flexible connecting pipe 15. Thus, only two flexible connecting pipes 15 are required per each heat transfer element 7. It is easy to protect the connecting pipes 15 with a protection plate 25 against the abrasion caused by the dried material. The steam manifold 14 common to several longitudinal pipes 8 can also be used in connection with a drying apparatus in which the heat transfer element is not a self-supporting packet consisting of several longitudinal pipes. In such a case, pipes belonging to different heat transfer elements are connected to the steam manifold.

An end view of the sector-shaped heat transfer element 7 is illustrated in FIG. 4. FIG. 4 shows the conduits of the flexible steam connecting pipes 15 at the top and the steam manifolds 14 connecting the different longitudinal pipe layers 8 at both edges of the heat transfer element 7. The connecting pipes 9 connect the adjacent longitudinal pipes 8. The steam manifolds 14, longitudinal pipes 8 and connecting pipes 9 constitute a continuous steam space, i.e. heat transfer element 7, where the steam can freely move in all directions.

The steam used as drying energy is conducted to the steam pressure vessel 17 by means of joints 18. The joint 18 thus allows rotation of the drum 1 and the pressure vessel connected to it, but the outer surface of the joint 18, to which the feed pipes for outside steam are connected, remains unrotatable. The rotating joint 18 comprises a fitting 23 for incoming steam and a fitting 24 for discharging condensation water. The condensation water is gathered at the bottom of the pressure vessel 17 due to the gravity and the rotational motion of the drum 1. From the bottom of the pressure vessel, the condensation water is led out by means of a stationary suction pipe 19 in the rotating joint 18.

The pressure vessel 17 is arranged at the end of the drum 1 and its diameter is so great that it extends to the area of the heat transfer elements 7. Thus, the connecting pipes 15 can be made fairly straight and short. If desired, the diameter of the pressure vessel 7 can be arranged to be of the same size as the diameter of the drum 1. In such a case, the connecting pipes 15 can be arranged, if desired, close to the outer casing of the drum 1.

The drawings and the related description are only intended to illustrate the idea of the invention. The details of the invention may vary within the scope of the claims. Thus, there may be a tilt mechanism with which the angle of inclination of the drum 1 can be adjusted. The angle of inclination can be adjusted between 0° and +5°, for example, and in this way the drying delay of the material to be dried can be controlled inside the drum.

1. A drying apparatus comprising a cylindrical rotatable drum, the inside of which is provided with a steam pipe system comprising heat transfer elements, to be rotated with the drum, the heat transfer elements being detachable from and mountable on the drum, whereby material to be dried is fed to a first end of the drying apparatus, the material being arranged to be discharged through a second end of the drying apparatus, wherein the heat transfer element is formed as a uniform packet of several longitudinal pipes and connecting pipes between them in such a way that the structure of the heat transfer element is formed self-supporting and this self-supporting packet is attached to the drum frame with fastening that allows heat expansion.

2. A drying apparatus according to claim 1, wherein the heat transfer element is formed as a sector-shaped packet in such a way that the heat transfer element comprising several longitudinal pipes at the edges of the element and of connecting pipes connecting them together.

3. A drying apparatus according to claim 1, wherein there is a two-part support structure in connection with the heat transfer element in such a way that the longitudinal pipes remain between the halves of the support structure.

4. A drying apparatus according to claim 1, wherein an abrasion resistant plate is arranged between the heat transfer element and the drum.

5. A drying apparatus according to claim 1, wherein there is a steam pressure vessel at the end of the drum of the steam drier and at least one steam manifold at the end of the heat transfer element, and the steam manifold is connected to the steam pressure vessel with a connecting pipe.

6. A drying apparatus according to claim 5, wherein the diameter of the steam pressure vessel extends to the area of the heat transfer elements.

7. A drying apparatus according to claim 5, wherein the steam drier comprises a protection plate for protecting the connecting pipe.

8. A drying apparatus according to claim 6 wherein the steam drier comprises a protection plate for protecting the connecting pipe.
